(19) United States
(12) Patent Application Publication
(10) Pub. No.: US 2020/0001559 A1
(43) Pub. Date: Jan. 2, 2020

(54) VENT SLEEVE FOR TIRE VULCANIZATION MOLD AND TIRE VULCANIZATION MOLD

(71) Applicant: TOYO TIRE CORPORATION, Itami-shi (JP)

(72) Inventor: Masaaki Ohara, Itami-shi (JP)

(73) Assignee: TOYO TIRE CORPORATION, Itami-shi (JP)

(21) Appl. No.: 16/446,925

(22) Filed: Jun. 20, 2019

(30) Foreign Application Priority Data
Jun. 29, 2018 (JP) 2018-124877

(51) Int. Cl. B29D 30/06

(52) U.S. Cl. CPC B29D 30/0606; B29K 2905/12; B29K 2905/02; B29D 2030/0617

(57) ABSTRACT

Disclosed is the invention having an object to prevent vent spew from being cut and clogged in vent holes of an aluminum mold in vulcanization molding of a tire containing an inorganic compounding agent. The present invention relates to a mold for vulcanizing and molding a tire containing an inorganic compounding agent, in which the mold is made of aluminum, and an embedded vent sleeve is made of stainless or metal containing 15% by mass or more of chromium.

### CROSS-REFERENCE TO RELATED APPLICATIONS

The present application claims the benefit of priority based on Japanese Patent Application No. 2018-124877, filed on Jun. 29, 2018, the entire content of which is incorporated herein by reference.

### BACKGROUND OF THE INVENTION

The present invention relates to a vent sleeve for a tire vulcanization mold, and a tire vulcanization mold using the same.

In a tire vulcanization mold used in a vulcanization process for a tire, a large number of small exhaust holes called vent holes are provided so as to exhaust air accumulated between the inner surface of the mold and a green tire to the outside of the mold at the time of vulcanization molding. In this vulcanization process, the green tire is heated in the mold at high temperature, and the green tire having low rigidity expands toward the inner surface of the mold by pressure of a bladder. Therefore, when the green tire is vulcanized and molded, a part of the expanded green tire enters the vent holes. For this reason, whisker-like projections called vent spew are formed on the surface of the tire removed from the mold after vulcanization molding. The vent spew is trimmed from the surface of the tire in a post process.

In recent years, inorganic compounding agents have been blended into tires for the purpose of low fuel consumption and reinforcement of a rubber layer.

However, when a green tire containing an inorganic compounding agent is vulcanized with a general aluminum vulcanization mold, a phenomenon that vent spew is cut in the vent holes to be clogged in the vent holes in the vulcanization process occurs. In addition, in the case of the green tire containing an inorganic compounding agent, it is necessary to vulcanize the tire at a relatively low temperature, so that the curing of the green tire needs a long time. As a result, there is a problem that the green tire enters the deep parts of the vent holes and is cut to be clogged.

In addition, in the case of using an aluminum vulcanization mold for manufacturing a tire containing an inorganic compounding agent, vulcanized rubber adheres to the inner surface of the mold and remains on the inner surface, causing a problem that it is difficult to thoroughly clean the mold.

Thus, if the vent spew is clogged in the vent holes or a part of the vulcanized rubber remains on the inner surface of the mold, it becomes difficult to exhaust the air to the outside of the mold in a vulcanization process for a subsequent tire, and a failure occurs in molding of a tire. In addition, there is a problem that it takes time to clean the inside of the mold and the manufacturing efficiency of a tire is lowered.

### SUMMARY OF THE INVENTION

As a result of earnest discussion under the problems that, in vulcanization molding of a tire containing an inorganic compounding agent, vent spew is clogged in vent holes of an aluminum mold and it is difficult to completely remove vulcanized rubber from the mold by cleaning, the inventors of the present invention have found that, in an aluminum vulcanization mold used for manufacturing a tire containing an inorganic compounding agent, for vent holes, using a sleeve made of stainless or a sleeve made of metal containing 15% by mass or more of chromium, the problem that vent spew is cut to be clogged in the vent holes can be solved, to thereby arrive at the present invention.

In addition, the inventors have been found that, in the inside of the aluminum mold after vulcanization process, the vulcanized rubber can be removed by cleaning with melamine resin beads, and re-adhesion can be suppressed, to thereby arrive at the present invention.

That is, in a first aspect according to the present invention, there is provided a mold for vulcanizing and molding a tire containing an inorganic compounding agent, wherein at least an inner surface of the mold is made of aluminum, and a vent sleeve is made of stainless or metal containing 15% by mass or more of chromium.

Further, in a second aspect according to the present invention, there is provided a cleaning agent and a cleaning method for a vulcanization molding mold for an inorganic compound tire using melamine resin beads.

According to the mold of the present invention, in manufacture of an inorganic compound tire having a reinforced rubber layer with low fuel consumption, the cut of vent spew at the time of vulcanization is suppressed, so that a tire can be manufactured efficiently.

In addition, a green tire remaining in the mold can be easily removed from the mold after vulcanization molding, and hence a tire can be manufactured efficiently.

### BRIEF DESCRIPTION OF THE DRAWINGS

FIG. 1 is a perspective view of an upper part of a vent sleeve of an embodiment, used in a mold of the present invention; and

FIG. 2 is a perspective view of an upper part of a vent sleeve of another embodiment, used in the mold of the present invention.

### DETAILED DESCRIPTION OF THE PREFERRED EMBODIMENTS

According to the present invention, there is provided a mold for vulcanizing and molding a tire containing an inorganic compounding agent, wherein at least an inner surface of the mold is made of aluminum, and at least an inner surface of a ventilation portion of a vent sleeve embedded in the mold is made of stainless or metal containing 15% by mass or more of chromium.

The present invention solves the problem of the cut of vent spew and remaining of a green tire in a mold, which are specifically caused in manufacture of a tire containing an inorganic compounding agent, with a vulcanization molding mold made of aluminum and a vent sleeve made of steel or metal containing 15% by mass or more of chromium to be embedded in the mold.

In the present specification, the inorganic compounding agent refers to an inorganic substance such as silica, which is blended for the purpose of improving the performance of a tire.

Vulcanization Mold

The mold for vulcanizing and molding a tire containing an inorganic compounding agent of the present invention is an aluminum mold generally used in a vulcanization process for a tire. At least the inner surface of the mold may be made of aluminum, or the entire mold may be made of aluminum.

Vent Sleeve

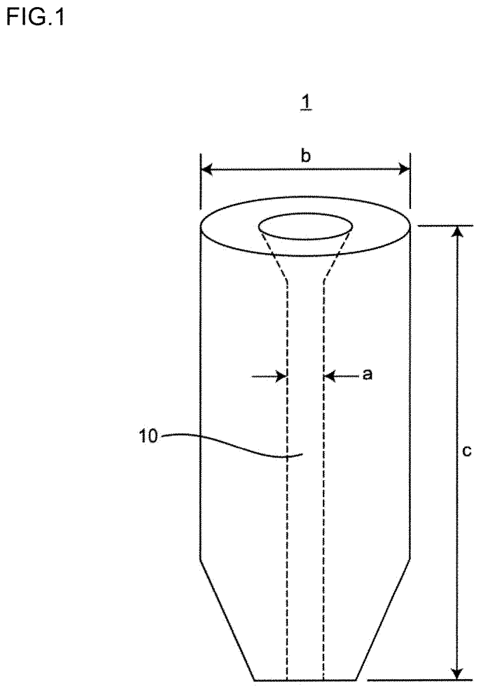

The vent sleeve used in the mold of the present invention will be described with reference to FIG. 1. In FIG. 1, an upper surface of a vent sleeve (1) forms an inner surface which is continuous with the inner surface of the mold when the vent sleeve (1) is embedded in the mold. In a preferred embodiment, the vent sleeve has a tapered cylindrical shape to facilitate embedding into an inside of a vent provided on the mold wall. At the center of the vent sleeve, a ventilation portion (10) is provided to exhaust air from inside the mold. In a preferred embodiment, the mold inner surface side of the ventilation portion is tapered such that the inner diameter decreases toward the mold outer side to promote the exhaust.

The vent sleeve is made of stainless at least at the portion with which a green tire comes in contact, that is, the upper surface and the inner surface of the ventilation portion, in particular, is made of metal containing 15% by mass or more of chromium. The entire vent sleeve may be made of stainless or metal containing 15% by mass or more of chromium. The portion with which a green tire comes in contact is made of stainless or metal containing 15% by mass or more of chromium. Thus, when the vulcanized tire is removed from the mold, a vent spew of the tire hardened after entering the ventilation portion is taken out together with the tire without being cut. Therefore, such a situation that the vent spew remains in the ventilation portion to prevent exhaust in a vulcanization process for a subsequent tire from is hindered. The vent spew taken out integrally with the tire is trimmed from the surface of the tire in a post process.

An inner surface roughness (Ra) of the mold or the ventilation portion of the vent sleeve is preferably about 0.5 to about 5.0, more preferably about 0.5 to about 3.0, most preferably about 2.0. If the inner surface roughness (Ra) of the ventilation portion exceeds 5.0, the friction with the vent spew increases when the tire is taken out of the mold, so that there is a risk that the vent spew may be cut to be clogged in the ventilation portion. On the other hand, even if the inner surface roughness (Ra) is less than 0.5, the vulcanized rubber adheres to the inner surface easily and the friction becomes large, so that there is a risk that the vent spew may be cut to be clogged in the ventilation portion.

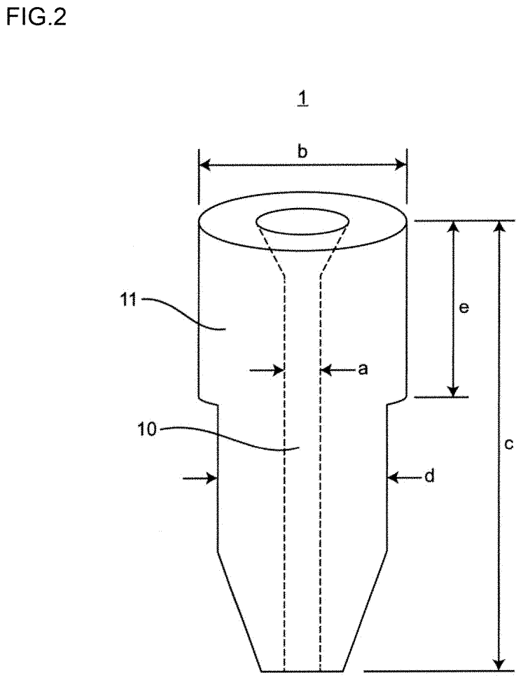

In another embodiment, the vent sleeve used in the mold of the present invention may be a stepped vent sleeve having a large diameter portion (11) as illustrated in FIG. 2. The vent sleeve of this embodiment is supported in contact with an inner surface of a hole formed in the vulcanization mold at the outer periphery of the large diameter portion. The area in contact with the vulcanization mold is smaller in the vent sleeve of this embodiment than that of the vent sleeve of the embodiment illustrated in FIG. 1, and hence the resistance at the time of press-fitting into the mold is reduced, and the processing becomes easy.

An inner diameter (a) of the ventilation portion of the vent sleeve is preferably 1 mm to 2 mm because this facilitates trimming of the vent spew. If the inner diameter of the ventilation portion is less than 1 mm, the vent spew will be too thin and trimming after the vulcanization process will be difficult, and if it exceeds 2 mm, the required time to complete a vulcanization process of a tire blank will be long, and the length of the vent spew will be long, so that there is a risk that the vent spew may be cut inside the ventilation portion when the tire is taken out of the mold to be clogged in the ventilation portion.

An overall length (c) of the vent sleeve is equal to or greater than the length of the vent spew to be generated. If the overall length of the vent sleeve is shorter than the length of the vent spew to be generated, the distal end of the vent spew will be located outside the vent sleeve, and at the position, the internal pressure holding of the vent spew by the inner surface of the vent sleeve is released, with the result that the diameter of vent spew expands. Also, the distal end of the vent spew which protrudes to the outside of the vent sleeve by the slight resistance difference of the inner surface of the vent spew and the internal pressure received from a bladder is deformed into a spiral and interlocked with the tire when the vulcanized tire is released from the mold. Consequently, the distal end of the vent spew cannot be traced back the inside of the vent sleeve, and the vent spew is cut. Further, in order to ensure the strength of the vent sleeve, the overall length (c) of the vent sleeve is preferably about 40 times or less of the thickness of the vent sleeve ((b−a)/2), more preferably 30 times or less. If the overall length (c) of the vent sleeve exceeds 40 times the thickness of the vent sleeve ((b−a)/2), buckling occurs when the vent sleeve is punched into the hole formed in the mold.

An actual contact surface length (e) with the die in the stepped vent sleeve is about 2 times or more, more preferably 3 times or more of a vent sleeve outer diameter (b). This stabilizes the embedding direction of the vent sleeve, a desired embedding angle can be obtained to reduce processing error, and transfer of a vent sleeve mark to the tire can be minimized.

Furthermore, in the stepped vent sleeve, the actual contact surface length (e) is set to satisfy the formula: a×π×20≤b×π×e (the ratio between the outer circumference to the inner circumference of the vent sleeve), which is an empirically obtained, from the viewpoint of heat transfer from the vulcanization mold to the vent sleeve. As a result, it is possible to secure the amount of heat received to the vent spew and to suppress the lengthening of the vent spew. However, when the actual contact surface length (e) is increased, the resistance at the time of pressing-fitting the vent sleeve into the mold also increases. The vent sleeve is embedded in the mold by impact to the upper surface or application of pushing force, but if the resistance at the time of press-fitting is increased, the upper surface is deformed (local diameter expansion only in the vicinity of the upper surface). If the upper surface is deformed, it becomes difficult to embed the vent sleeve to a desired depth, and the quality of the mold is also degraded. Therefore, the actual contact surface length (e) is preferably 40% or less of the overall length (c) of the vent sleeve, preferably 15 times or less of the vent sleeve thickness ((b−a)/2), more preferably less than 10 times of the vent sleeve thickness ((b−a)/2).

As a stepped vent sleeve which satisfies these dimensional conditions, one which has a ratio of a=1.2, b=3.0, c=25, d=2.8, e=9.0 can be given, for example.

With the use of a stepped vent sleeve which satisfies such dimensional conditions, both of the problems of the applicability to the mold and cut of the vent spew are solved, and a short vent spew is generated, so that trimming of the vent spew from the tread surface of the tire after the vulcanization process is facilitated.

The vent sleeve used in the present invention is made of stainless steel, preferably austenitic stainless steel, or metal containing 15% by mass or more of chromium, and hence can be manufactured by drawing processing such as swaging processing or drawing processing. The vent sleeve manufactured by drawing processing is preferable in that processing marks extend in the axial direction of the vent sleeve, and hence the resistance at the time of tire release is small, and that the adhesion to rubber decreases as the content of chromium increases, so that the vent spew is less liable to cut.

The present invention also provides, in another aspect, a cleaning agent for a mold for vulcanizing and molding a tire containing an inorganic compounding agent.

In discussion of the problem of cut of the vent spew at the time of vulcanization molding of a green tire containing an inorganic compounding agent, the inventors of the present invention have found out a phenomenon that, even if the inside of the vulcanization molding mold is cleaned using glass beads, a part of the vulcanized rubber remains on the inner surface of the mold.

In order to solve this problem, as a result of testing of various cleaning agents by the inventors of the present invention, it has been found that by using resin beads instead of glass beads, the vulcanized rubber on the inner surface portion of the mold can be removed. As the resin beads, the whole bead may be made of resin, or the bead surface may be coated with resin, and it is preferable to use a bead made of melamine resin or a bead coated with melamine on its surface. With use of mixed beads with a particle size of 50 μm to 700 μm, more preferably 100 μm to 500 μm, a balance between removal of vulcanized rubber in every part and cleaning time can be balanced.

The present invention also provides a cleaning method for a mold having an inner surface made of aluminum, for vulcanizing and molding a tire containing an inorganic compounding agent, using this cleaning agent.

The vent sleeve of the present invention can be used as a vent piece of a vulcanization mold of a tire containing an inorganic compounding agent. In addition, the cleaning agent for the mold of the present invention can be used to clean the vulcanization mold of a tire containing an inorganic compounding agent.

What is claimed is:

1. A mold for vulcanizing and molding a tire containing an inorganic compounding agent, wherein the mold is made of aluminum, and an embedded vent sleeve is made of stainless or metal containing 15% by mass or more of chromium.

2. The mold according to claim 1, wherein a roughness (Ra) of an inner surface of a ventilation portion of the vent sleeve is 0.5 or more and less than 5.0.

3. The mold according to claim 1, wherein an overall length (c) of the vent sleeve is 10 times or more of a diameter (a) of the ventilation portion.

4. The mold according to claim 2, wherein an overall length (c) of the vent sleeve is 10 times or more of a diameter (a) of the ventilation portion.

5. The mold according to claim 1, wherein an overall length (c) of the vent sleeve is 20 to 40 times a wall thickness ((b−a)/2) of the vent sleeve.

6. The mold according to claim 2, wherein an overall length (c) of the vent sleeve is 20 to 40 times a wall thickness ((b−a)/2) of the vent sleeve.

7. The mold according to claim 3, wherein an overall length (c) of the vent sleeve is 20 to 40 times a wall thickness ((b−a)/2) of the vent sleeve.

8. The mold according to claim 1, wherein the vent sleeve is tapered toward an outer surface of the mold.

9. The mold according to claim 2, wherein the vent sleeve is tapered toward an outer surface of the mold.

10. The mold according to claim 3, wherein the vent sleeve is tapered toward an outer surface of the mold.

11. The mold according to claim 1, wherein the vent sleeve is a stepped vent sleeve having a large diameter portion.

12. The mold according to claim 2, wherein the vent sleeve is a stepped vent sleeve having a large diameter portion.

13. The mold according to claim 3, wherein the vent sleeve is a stepped vent sleeve having a large diameter portion.

14. The mold according to claim 11, wherein an actual contact surface length (e) of the large diameter portion of the vent sleeve with an inner surface of the mold is about 2 times or more of a vent sleeve outer diameter (b).

15. The mold according to claim 11, wherein an actual contact surface length (e) of the large diameter portion of the vent sleeve with an inner surface of the mold satisfies a×π×20≤b×π×e (a ratio between an outer circumference and an inner circumference of the vent sleeve).

16. The mold according to claim 14, wherein an actual contact surface length (e) of the large diameter portion of the vent sleeve with an inner surface of the mold satisfies a×π×20≤b×π×e (a ratio between an outer circumference and an inner circumference of the vent sleeve).

17. The mold according to claim 8, wherein the vent sleeve is a vent sleeve manufactured by drawing processing.

18. A cleaning agent for cleaning a mold having an inner surface made of aluminum, for vulcanizing and molding a tire containing an inorganic compounding agent, wherein the cleaning agent is resin-based beads.

19. The cleaning agent according to claim 18, wherein the cleaning agent is beads made of melamine-based resin or coated on a surface with melamine-based resin.

20. A cleaning method for a mold having an inner surface made of aluminum, for vulcanizing and molding a tire containing an inorganic compounding agent, wherein the cleaning agent according to claim 18 is used.
